(19) United States
(12) Patent Application Publication
(10) Pub. No.: US 2007/0055517 A1
(43) Pub. Date: Mar. 8, 2007

(54) Multi-factor biometric authentication

(76) Inventor: Brian Spector, San Francisco, CA (US)

Correspondence Address: JAMES D IVEY, 3025 TOTTERDELL STREET, OAKLAND, CA, 94611-1742, US

(21) Appl. No.: 11/217,074

(22) Filed: Aug. 30, 2005

(51) Int. Cl. G10L 17/00

(52) U.S. Cl. 704/246

(57) ABSTRACT

A method for verifying a person's identity in order to gain access to electronic data, a data network, a physical location, or enable a commercial transaction. A request for identity verification is processed over a data network and the system is initiated which (i) transmits a disposable pass phrase over a data network to the user, (ii) prompts the user to vocalize the disposable pass phrase, a pass phrase, and user id, (iii) compares the recited speech of the user to the stored voiceprint of the user, the stored pass phrase and id of the user, and the generated disposable pass phrase, then (iv) issues a token or signal that represents whether the user was verified or not.

### FIELD OF THE INVENTION

The present invention relates to computer security authentication and, in particular, to a particularly effective multi-factor authentication mechanism that does not require additional hardware for disposable pass phrase management.

### BACKGROUND

The use of data networks for all forms of communication has become pervasive over the past several years. The use of the Internet and voice networks to access data and complete business transactions is commonplace.

Of principal concern to the many businesses and individuals that use the Internet or data networks for commerce or general business use is the security of these networks, specifically, how to best enable the authentication of a user's identity.

Instances where users of these business services or data networks have had their identities spoofed or authentication credentials stolen have resulted in credit card fraud, confidential information loss, identity theft, and fraudulent bank transactions.

There are many authentication methods in the marketplace today that serve to authenticate an individual's identity in order to gain access to a data network or complete a commercial transaction. However, these solutions have many negative aspects which ultimately slow down the adoption of technologies which can be very beneficial to consumers and businesses alike.

Two such aspects are manageability and cost. Solutions that require users to carry a piece of equipment, such as a disposable pass phrase generator or smart card, are expensive to deploy and costly to manage. While these solutions can provide a great deal of security, these solutions require back-end infrastructure, including personnel to maintain the infrastructure and support the user population. For every user of a given implementation of these solutions that require additional hardware for authentication, there is an associated cost with deploying these authentication devices.

In light of the present state of the market, there is a need in the art for an improved method of ascertaining an individual's identity for access to data networks or physical locations or to insure the identity of an individual involved in a commercial transaction. Such a method should not be prohibitive in cost and complexity and yet should offer multiple factors of authentication rather than static username and pass phrase.

### SUMMARY OF THE INVENTION

The problematic aspects of the prior art, which include those stated above and others, are reduced by the present invention which relates to a technique of verifying an individual's identity through the use of that individual's voice, stored voice samples, identifiers, pass phrases and the transmission of a disposable pass phrase. For example, a (i) voice registration unit, (ii) a voice print storage unit, a (iii) voice recognition unit, and a (iv) disposable pass phrase generator are attached to a data network and cooperate to verify a user's voice in addition to other authentication factors.

As an example, using one incarnation of the invention, a user wishes to be registered on the system, and can apply to sign up to the authentication system using a web service, or a system administrator can create an account. Once a user account is created, the user would enroll in the system by providing the system with a voice sample by speaking pass phrases and the user's name. Additionally, the user would be required to speak a series of disposable pass phrase elements, such alphanumeric characters or other elements, that would serve another basis of comparison when the user is subsequently required to speak a disposable pass phrase.

To be authenticated for the purpose of accessing a data network or information or of engaging in a commercial transaction, the user recites the user's name, pass phrase, and the disposable pass phrase that had been communicated to the user during the authentication session. The user's voice pattern, name, and pass phrase are compared to the data on file for a match. The disposable pass phrase is compared to the disposable pass phrase elements to verify the user's voice, checked to see if the spoken pass phrase matches the disposable pass phrase, and if the spoken pass phrase was recited by the user within the time frame allowed for the life of the disposable pass phrase.

The authentication system can initiate communication with the user via a client process, a browser, or an application on a computer in order to transmit the disposable pass phrase, for vocalizing the username and pass phrase, or all of the preceding. Additionally, the authentication system can open a communication channel over a standard telephone network (PSTN, public switched telephone network), or cellular/wireless telephone network for the purpose of transmitting the disposable pass phrase and receiving the user's spoken name, pass phrase, and disposable pass phrase. In all such cases, the verification of the user's spoken name, pass phrase, disposable pass phrase, and the transmission of the disposable pass phrase can occur over all networks: data, cellular, or voice in any combination.

### BRIEF DESCRIPTION OF THE DRAWINGS

FIG. 1 is a logic flow diagram illustrating authentication of a user in accordance with the present invention.

FIGS. 2A and 2B are logic flow diagrams illustrating the registration of the user for subsequent authentication in the manner illustrated in FIG. 1.

FIG. 3 is a network diagram showing an identity authentication unit that performs authentication in accordance with the present invention and connected data network networks and computer systems.

FIG. 4 is a block diagram of the identity authentication unit of FIG. 3 in greater detail.

FIG. 5 is a block diagram of an identity used by the identity authentication unit of FIG. 4 to authenticate an associated user.

FIG. 6 is a logic flow diagram illustrating authentication in an interactive voice response system in accordance with the present invention.

FIG. 7 is a network diagram showing the identity authentication unit of FIG. 3 coupled with an advertising server and a call center in accordance with an alternative embodiment.

FIG. 8 is a transaction flow diagram illustrating the interjection of targeted advertising messages into an authentication process according with the present invention.

### DETAILED DESCRIPTION

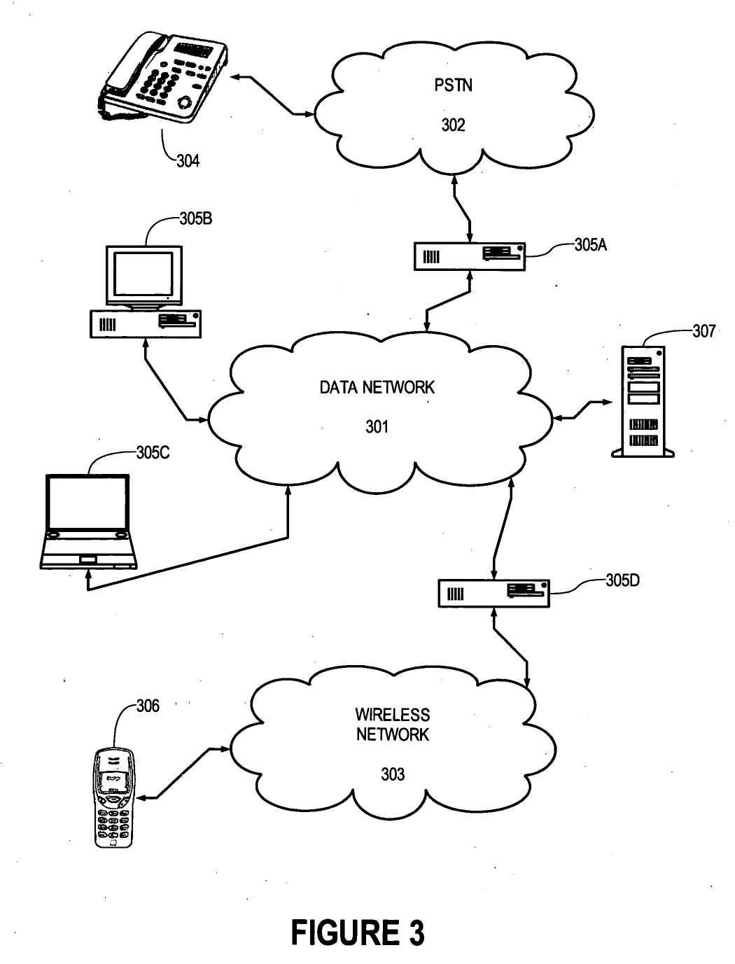

In accordance with the present invention, an identity authentication unit 307 (FIG. 3) implements a multi-factor authentication system in which a person's voice in speaking a disposable pass phrase is used as a biometric factor. The user can also speak a username and a pass phrase for authentication.

Much of the complexity in disposable password systems used today is the communication of the disposable password to the user. In some conventional systems, a user carries a pseudo-random password generator device that is synchronized with a master password generator. Thus, the disposable password, both as represented by the device carried by the user and as represented within the master password generator, changes periodically in a pseudo-random and synchronized manner. From the perspective of many, this is just one more thing for a busy professional to lose and an expensive and/or complex business resource to manage.

In the authentication system of identity authentication unit 307, the disposable pass phrase can be passed in the clear, i.e., through insecure communication channels, since the authentication factor is not the disposable pass phrase itself but rather the biometric of the user's voice in speaking the disposable pass phrase. The disposable pass phrase consists of a number of elements of speech, a complete set of which are recorded from the user during account initialization. In this illustrative embodiment, the elements are alphanumeric characters such as letters and numbers.

Speaking the user's name and pass phrase provides good security, because the name and pass phrase should be kept secret and are therefore themselves difficult to ascertain. In addition, the user's voice is extremely difficult to imitate sufficiently well to fool currently available voice recognition systems. However, one might surreptitiously capture a recording of the user speaking the user's name and pass phrase, thereby gaining the ability to spoof the user's spoken name and pass phrase. It is considerably more difficult to surreptitiously capture a recording of the user speaking the alphabet and counting from zero to nine or otherwise reciting a complete set of elements used in forming the disposable pass phrases. Even assuming such a recording can be acquired, it is quite difficult to assemble such recorded spoken elements to recite a disposable pass phrase within just a few seconds of receiving it. For example, if the authentication system directs the user being authenticated to “repeat the following: A-2-D-J-4-H-I,” it would be extremely difficult to generate, within just a few seconds, a sound signal of the user's voice speaking “A-2-D-J-4-H-I” from prerecorded material to fool the authentication system described herein.

Identity authentication unit 307 verifies the identity of an individual at the time the individual requests use of a secured resource. In this illustrative example of FIG. 3, identity authentication unit 307 is coupled to a data network 301, which is the Internet in this example. A number of computers 305A-D are also coupled to data network 301. Computer 305A serves as a gateway between data network 301 and PSTN 302 to which a wired telephone 304 is coupled. Computer 305D serves as a gateway between data network 301 and wireless network 303 with which a mobile telephone 306 is in communication. In this example, an individual, sometimes referred to herein as the user, can be using telephone 304, computer 305C, and/or mobile telephone 306 to gain access to restricted resources. In addition, computer 305B provides access to the target restricted resources. For example, computer 305B (i) can store restricted data, access to which the user wants; (ii) can carry out financial transactions, either through data network 301 as e-commerce or as a component of a point-of-sale (POS) equipment in a physical store; and (iii) can control an electronically controlled lock on a door or gate at a restricted access building or site.

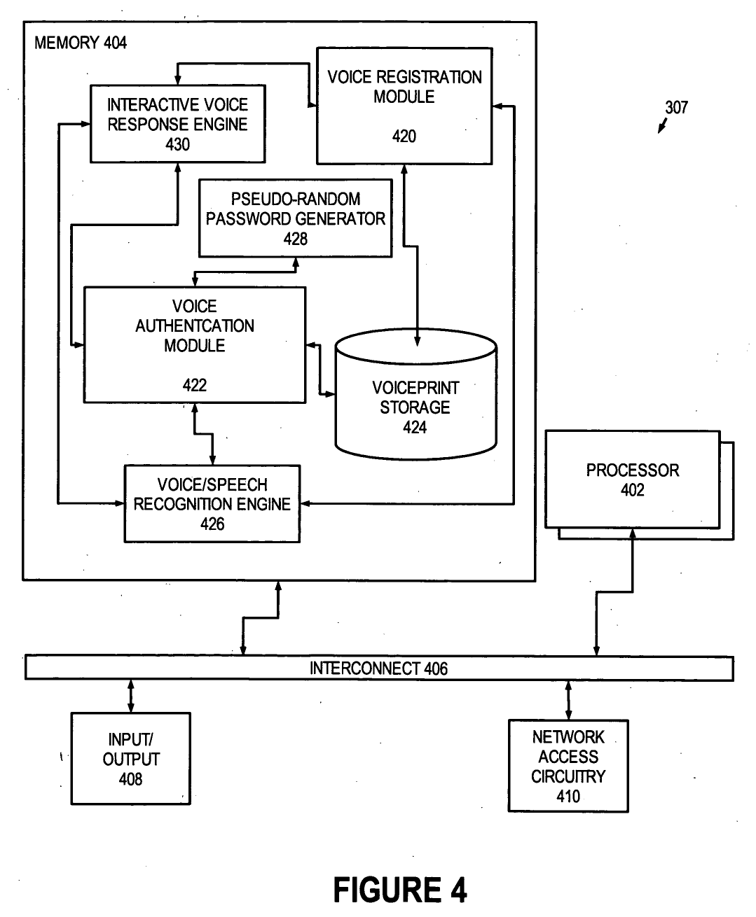

Some elements of identity authentication unit 307 are shown in diagrammatic form in FIG. 4. Identity authentication unit 307 includes one or more microprocessors 402 that retrieve data and/or instructions from memory 404 and executes retrieved instructions in a conventional manner. Memory 404 can include persistent memory such as magnetic and/or optical disks, ROM, and PROM and volatile memory such as RAM.

Microprocessors 402 and memory 404 are connected to one another through an interconnect 406 which is a bus in this illustrative embodiment. Interconnect 406 is also connected to one or more input and/or output devices 408 and network access circuitry 410. Input/output devices 408 can include, for example, a keyboard, a keypad, a touch-sensitive screen, a mouse, a microphone as input devices and can include a display—such as a liquid crystal display (LCD)—and one or more loudspeakers. In this example, identity authentication unit 307 is configured as a server and is not intended to be used directly in conjunction with physical manipulation of input device by a human operator and can therefore omit input/output devices 408. However, some maintenance by a human operator is required and input/output device 408 can be included for that purpose. Network access circuitry 410 sends and receives data through a network communications channel. In this illustrative embodiment, network access circuit 410 is Ethernet circuitry. Network access circuitry 410 can also provide a mechanism for control by a human operator using a remotely located computer, e.g., for maintenance purposes.

To authenticate the identity of the user, identity authentication unit 307 includes a voice authentication module 422 that receives voice signals from the user and confirms the identity of the user from the voice signals. Identity authentication unit 307 also includes a voice registration module 420 to collect information and voice samples from individuals for subsequent authentication by voice authentication module 422. In addition, identity authentication unit 307 includes: (i) a voiceprint storage database 424, (ii) a voice/speech recognition engine 426, (iii) a pseudo-random pass phrase generator 428, and (iv) an interactive voice response (IVR) engine 430.

Each of voice authentication module 422, voice registration module 420, voice/speech recognition engine 426, pseudo-random pass phrase generator 428, and IVR engine 430 is part or all of one or more computer processes executing in processors 402 from memory 404. In addition, while identity authentication unit 307 is shown and described as a single computer, it should be appreciated that identity authentication unit 307 can be implemented using multiple computers cooperating to provide the functionality described herein.

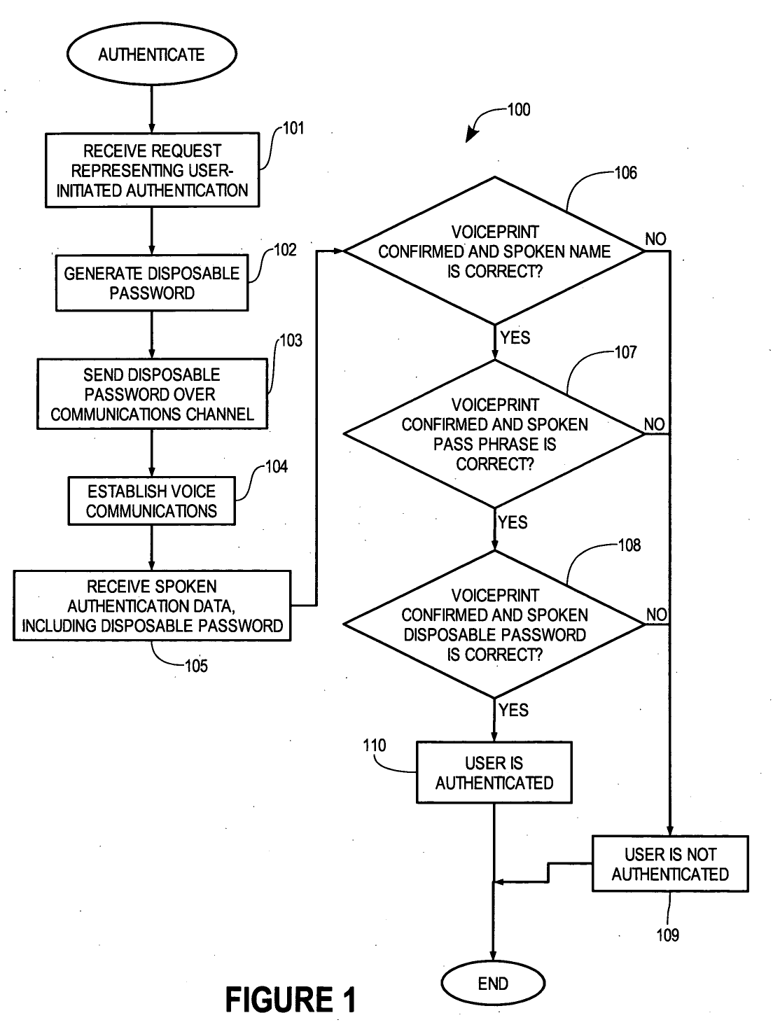

The process by which the user of the system is authenticated by voice authentication module 422 of identity authentication unit 307 is shown as logic flow diagram 100 (FIG. 1). However, it may facilitate appreciation and understanding of the present invention to consider a few examples of the user's experience in being authenticated by identity authentication unit 307.

In the first example, the user approaches a door to a restricted building and places an identification badge in close proximity to an RFID reader at the door. A voice from an intercom asks the user to state her name. The user states her name into the intercom. The voice from the intercom asks the user to state her pass phrase, and the user complies, stating her pass phrase into the intercom. The voice from the intercom asks the user to “repeat the following: X-2-J-M-N-3,” X-2-J-M-N-3 being a disposable pass phrase. The user complies, stating “X-2-J-M-N-3” into the intercom. Alternatively to being prompted by the voice from the intercom, a small LCD display on the intercom can prompt the user by displaying a request that the user state the disposable pass phrase. In addition, the identification badge can be omitted and the user can identify herself solely by speaking her name. This alternative embodiment adds the complexity of comparing the spoken name to all prerecorded names of all registered users but obviates the use of identification badges. In a similar example, the authentication request is responsive to a swiping of a credit card through a magnetic stripe reader at a merchant's point-of-sale equipment. The intercom can resolve any doubts as to the identity of the person presenting the credit card.

In the second example, the user attempts to access restricted data stored within computer 305B from computer 305C. Upon such attempted access, the user is asked for a name and pass phrase combination within computer 305C. The user can be asked to enter such information textually or orally, i.e., by speaking. The authentication dialog can be implemented in a manner similar to the textual and voice interfaces provided by current voice-enabled instant messaging (IM) clients such as Skype™ IM client from Skype Technologies S.A. and the pulver.communicator IM client from FWD Communications.

The voice portion of this second example follows the first example, except that the interactive voice response (IVR) dialog is carried out through the voice-capable IM client. In a variation of this second example, the IVR portion of the authentication process is carried out through mobile telephone 306, the number of which is associated with the user during registration. Beyond the benefits described elsewhere herein, initiating a voice call to a mobile telephone associated with the user for the voice portion of the authentication process adds the benefit of alerting the user to attempts at spoofing the user's identity. In particular, attempted authentication by another using the identity of the user will result in a telephone call to mobile telephone 306, thereby alerting the user to such attempted fraudulent authentication.

In the third example, the user places a voice call through telephone 304, or alternatively through mobile telephone 306, to access restricted information, such as information related to financial accounts, stored in computer 305B and accessible through an IVR interface. The voice interaction can be directly analogous to that described above with respect to the first two examples, except that the IVR is carried out entirely through the telephone used to request access to the restricted data. To facilitate identification of the user, and therefore obviate comparison of a spoken user name, the user can use a keypad on the telephone to send dual-tone, multiple frequency (DTMF) signals representing numerical identification data, e.g., an account number.

Identity authentication unit 307 authenticates users in the manner described above as shown in logic flow diagram 100 (FIG. 1). In step 101, voice authentication module 422 receives a request representing user-initiated authentication. To generate this request, the user attempts access to any restricted resource as described previously. For example, by using any of telephone 304, computer 305C, or mobile telephone 306, the user can attempt access to restricted resources within computer 305B. In addition, the user can attempt access to the restricted resources directly through computer 305B. For example, computer 305B can be an automatic teller machine (ATM) or similar self-serve POS device. Alternatively, computer 305B can be POS equipment at which a store clerk identifies the user by swiping a magnetic strip card, such as a credit card or drivers license, through a magnetic stripe reader. In addition, the user can interact directly with computer 305B through a keypad or identification badge reader for attempted access into a restricted room, building, or area. In response to any of these or other types of attempted access to restricted resources, computer 305B sends a request for authentication to identity authentication unit 307. The request includes some data identifying the user attempting access. In an alternative embodiment, the request does not identify the user.

Computer 305B awaits for a response from identity authentication unit 307, and the response indicates whether access to the restricted resource should be granted. It should be appreciated that the functionality of identity authentication unit 307 can be integrated into computer 305B such that computer 305B is capable of authenticating users itself rather than the service-based architecture described herein.

In response to the received request, voice authentication module 422 causes pseudo-random pass phrase generator 428 (FIG. 4) to generate a disposable pass phrase in step 102 (FIG. 1). Disposable pass phrase generation is known and is described herein only briefly for completeness and to describe the specific characteristics of disposable pass phrase generation by pseudo-random pass phrase generator 428. The pass phrase is disposable in that the pass phrase is generated anew each time a user is to be authenticated and is not stored for use in subsequent authentication sessions. Disposable pass phrases are sometimes referred to as one-time pass phrases; however, such can be misleading since disposable pass phrases are permitted to repeat in this illustrative embodiment. However, for a given user, disposable pass phrases are not permitted to repeat within a predetermined interval, e.g., the 100 most recently used disposable pass phrases. The important characteristic of disposable pass phrases is that the user typically cannot predict the pass phrase before the authentication process starts.

The disposable pass phrase can have a fixed length or a random length between predetermined minimum and maximum lengths. For each element of the disposable pass phrase, pseudo-random pass phrase generator 428 pseudo-randomly selects an element from the set of prerecorded voice elements collected from the user during registration (described more completely below). The length of the disposable pass phrase should be selected to be sufficiently long so as to make repeated selection of a previously used disposable pass phrase highly unlikely but sufficiently brief that the user can hear the pass phrase, remember the pass phrase, and recite the pass phrase relatively easily. In circumstances involving particularly sensitive resources, the pass phrase can be parsed into multiple parts and the user can be asked to recite each part in sequence, thereby allowing particularly long pass phrases without overwhelming the short-term memory of the user.

As described above, the elements are letters and numerals in this illustrative embodiment. However, other sets of elements can be used in alternative embodiments. For example, during registration, the user can be asked to recite “the quick brown fox jumps over the lazy dog” and the disposable pass phrase can be pseudo-randomly selected words from the phrase. For example, the disposable pass phrase could be “jumps fox lazy the dog.” A larger word element set, and therefore a more varied disposable pass phrase selection mechanism, can be achieved by having the user read a paragraph of prose during registration to produce a rich collection words from which to select pass phrases.

In step 103, voice authentication module 422 transmits the disposable pass phrase to the user through one or more of data network 301, PSTN 302, and wireless network 303. As described above, the disposable pass phrase can be transmitted in either a voice or text format. As text, voice authentication module 422 can send the disposable pass phrase to computer 305C or computer 305D as an e-mail or instant message or can send the disposable pass phrase to mobile telephone 306 as an SMS (Short Messaging Service) message. As a synthesized voice, voice authentication module 422 can send the disposable pass phrase through PSTN 302 to telephone 304 or wireless network 303 to mobile telephone 306 as an analog voice signal or to computer 305B or 305D as voice over data network signals, e.g., VoIP data.

In step 104, voice authentication module 422 establishes voices communications with the user. Initiation of the voice communication session can be by either the user or voice authentication module 422, depending on preferences specified during the registration process. Thus, establishment of voice communications with the user can be initiating voice communications with the user, e.g., placing a telephone call to telephone 304 or mobile telephone 306 or initiating an IM voice session with computer 305C, or can be accepting voice communications initiated by the user.

In step 105, voice authentication module 422 causes IVR engine 430 to conduct an IVR session with the user over the voice communications channel to prompt for and receive the spoken name, pass phrase, and disposable pass phrase from the user in the manner described above with respect to the various examples of the user's experience.

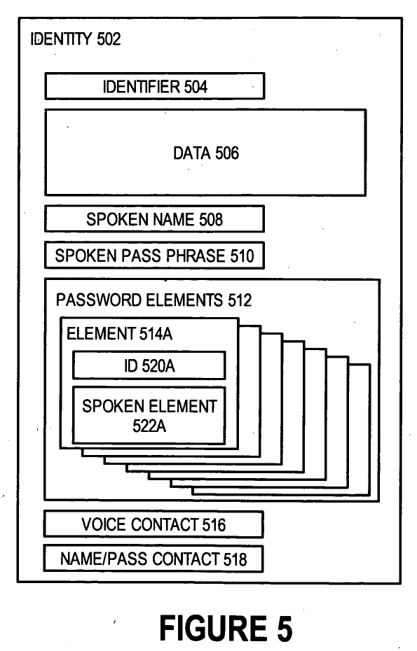

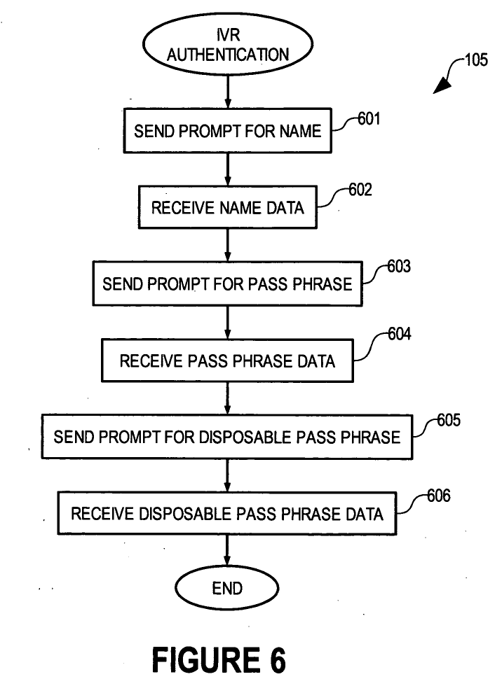

Step 105 is shown in greater detail as logic flow diagram 105 (FIG. 6). In step 601, voice authentication module 422 sends a prompt for name information to the user. In some embodiments, how to send this prompt is fixed. In the example described above in which the user speaks to computer 305B through an intercom, the prompt can be sent to the intercom regardless of the identity of the user. In other embodiments, voice authentication module 422 sends the prompt in accordance with preferences of the user as stored in an identity 502 (FIG. 5) which is stored within voiceprint storage 424 (FIG. 4). Identity 502 (FIG. 5) includes name/pass phrase contact 518, which stores data representing a manner of contacting the user associated with identity 502 for prompting and receiving name and pass phrase information. In particular, name/pass phrase contact 518 represents a type of contact and an address. The type can indicate e-mail, SMS, telephone, or voice IM, for example. The address can be, respectively, an e-mail address, an SMS address (either e-mail address or telephone number), a telephone number, or a voice IM user identifier. Name/pass contact 518 can also specify (i) that the voice contact, represented by voice contact 516, should be used or (ii) that the user prefers to contact voice authentication module 422 rather than being contacted. As described above, the prompt can be textual or voice, synthesized or prerecorded.

In step 602, voice authentication module 422 receives name data from the user. In some embodiments, this name data can be textual. In other, more secure embodiments, the name data is digitized audio data captured from the user speaking her name. Capturing and digitizing of audio signals is known and is not described further herein.

In step 603, voice authentication module 422 sends a prompt for the pass phrase of the user in a manner directly analogous to the sending of the prompt for the name of the user described above with respect to step 601.

In step 604, voice authentication module 422 receives pass phrase data from the user in a manner directly analogous to the receiving of the name data from the user described above with respect to step 602.

In step 605, voice authentication module 422 sends a prompt for the user to speak the disposable pass phrase. The prompt can be sent either in accordance with name/pass phrase contact 518 or in accordance with voice contact 516. Voice contact 516 is analogous to name/pass phrase contact 518 except that voice contact 516 is limited to voice communications media, e.g., telephone, voice IM, voice over Internet protocol (VoIP), etc. If voice authentication module 422 uses voice contact 516 to prompt the user to speak the disposable pass phrase and if voice contact 516 specifies a different type or address than does name/pass phrase contact 518, voice authentication module 422 establishes a new communications channel with the user in accordance with voice contact 516.

As described above, the disposable pass phrase is transmitted to the user in step 103 (FIG. 1). In an alternative embodiment, the disposable pass phrase is communicated to the user in step 605 as part of the prompt to the user to speak the disposable pass phrase. In this alternative embodiment, step 103 is omitted.

In step 606, voice authentication module 422 receives data representing the user's voice speaking the disposable pass phrase. If voice authentication module 422 uses name/pass phrase contact 518 to prompt the user to speak the disposable pass phrase and if voice contact 516 specifies a different type or address than does name/pass phrase contact 518, voice authentication module 422 establishes a new communications channel with the user in accordance with voice contact 516 to receive the data representing the user's voice speaking the disposable pass phrase. After step 606, processing according to logic flow diagram 105, and therefore step 105 (FIG. 1), completes.

In test step 106, voice authentication module 422 compares the data received in step 602 to spoken name 508 (FIG. 5) of identity 502 representing the purported identity of the user being authenticated. Spoken name 508 stores data representing a captured and digitized sound of the user associated with identity 502 speaking the user's name and is captured during registration as described more completely below. In some embodiments, the purported identity of the user being authenticated is known by voice authentication module 422 prior to test step 106 and identity 502 can be selected with certainty. Such embodiments involve some identification of the user prior to authentication, such as the swiping of a credit card through a magnetic stripe reader or the reading of an RFID tag embedded in an employee identification badge. In other embodiments, the purported identity of the user being authenticated is unknown and test step 106 involves comparison of the data received in step 602 to the spoken names, e.g., spoken name 508, of numerous identities stored in voiceprint storage 424 to identify the speaking user. Voice authentication module 422 determines the identity whose spoken name most closely matches the data received in step 602 and compares a degree of certainty of a match to a predetermined threshold. If the degree of certainty is at least the predetermined threshold, voice authentication module 422 considers the closest matching spoken name to identify the user being authenticated.

To make this comparison, voice authentication module 422 uses voice/speech recognition engine 426. Various voice/speech recognition engines exist and any can serve as voice/speech recognition engine 426. Examples include the following: (i) Advanced Speech API (ASAPI) by AT&T Corp.; (ii) Microsoft Windows Speech API (SAPI) by Microsoft Corporation; (iii) Microsoft Windows Telephony API (TAPI) by Microsoft Corporation; and (iv) Speech Recognition API (SRAPI) by the SRAPI Committee. The SRAPI Committee is a nonprofit Utah corporation with the goal of providing solutions for interaction of speech technology with applications. Core members include Novell, Inc., Dragon Systems, IBM, Kurzweil AI, Intel, and Philips Dictation Systems. Additional contributing members include Articulate Systems, DEC, Kolvox Communications, Lernout and Hauspie, Syracuse Language Systems, Voice Control Systems, Corel, Verbex and Voice Processing Corporation.

The comparison made by voice authentication module 422 is more simple than the typical speech-to-text translation provided by these various speech engines. The data received in step 602 is a captured and digitized utterance and the data stored as spoken name 508 (FIG. 5) is similarly a captured and digitized utterance. The comparison involves comparing the respective utterances to determine whether they represent the same person saying the same thing. The mechanics of such a comparison are known and are not described herein.

The determination made by voice authentication module 422 in test step 106 is whether the received data of step 602 represents the same person saying the same thing as recorded in spoken record 508 if identity 502 is known to be applicable, e.g., identified before test step 106, or whether the received data of step 602 matches any prerecorded spoken name of any identity with a predetermined degree of certainty. If no match is detected, processing transfers to step 109 in which the user is not authenticated. Conversely, if a match is detected, processing transfers to test step 107.

It should be appreciated that, in embodiments in which the user's name is provided textually, the comparison of step 106 is a simple comparison of textual data. Data 506 (FIG. 5) of identity 502 represents data of the user associated with identity 502 and stores such things as textual representations of the user's name and pass phrase. Alternatively, the user's name can be used as identifier 504 which identifies identity 502 uniquely within voiceprint storage 424. Data 506 can store other information such as the user's address, citizenship, and other demographic information, for example.

It should also be appreciated that, in this illustrative embodiment, the period for response by the user is limited, particularly if the user's name is to be spoken rather than entered textually. The user should be able to respond orally almost instantaneously to a prompt to speak her name. Accordingly, a delay of more than a predetermined amount of time, e.g., three (3) seconds, in responding to such a prompt is interpreted as an invalid response to such a prompt, as if the user had spoken a different name or using a different voice.

By test step 107, the purported user whose identity is being authenticated is determined regardless of whether the user was identified prior to test step 106. In test step 107, voice authentication module 422 compares the data received in step 604 to spoken pass phrase 510 of the user being authenticated, i.e., the user associated with identity 502. This comparison is analogous to that described above with respect to test step 106 in embodiments in which the user is identified prior to test step 106. If the data received in step 604, representing the pass phrase as recently spoken by the user, does not match spoken pass phrase 510—which is recorded and captured and digitized during registration as described more completely below—in either content or the uniqueness of the voice of the user, processing transfers to step 109 and the user is not authenticated. Conversely, if the data received in step 604 matches spoken pass phrase 510, both in content and in the unique qualities of the user's voice, processing transfers to test step 108.

It should be appreciated that, in embodiments in which the user's pass phrase is provided textually, the comparison of step 107 is a simple comparison of textual data. As described above, data 506 can store a textual representation of the pass phrase of the user associated with identity 502. It should also be appreciated that the period for providing the user's pass phrase can be limited to a predetermined time period, e.g., three (3) seconds from the time the user is prompted to provided the pass phrase.

In test step 108, voice authentication module 422 compares data representing the disposable pass phrase spoken by the user that is received in step 606 to a series of spoken elements such as spoken element 522A. Each of the elements from which pseudo-random pass phrase generator 428 can compose disposable pass phrases is represented in pass phrase elements 512 of identity 502. pass phrase elements 512 includes a number of elements, such as element 514A and of which element 514A is accurately representative.

Element 514A includes an identifier 520A and a spoken element 522A. Element 514A represents one of the elements from which disposable pass phrases can be composed. In this illustrative embodiment, such elements include letters and numerals. Accordingly, element 514A represents a letter or a numeral. Identifier 520A indicates the particular letter or numeral represented by element 514A. In this embodiment, identifier 520A is represented explicitly. In other embodiments, identifier 520A can be represented implicitly, e.g., by a relative position of element 514A within pass phrase elements 512.

Spoken element 522A represents a captured and digitized audio signal of the user associated with identity 502 speaking the letter or numeral represented by element 514A.

To compare the disposable pass phrase as uttered by the user being authenticated to the disposable pass phase as it would be uttered by the user associated with identity 502, a number of spoken elements such as spoken element 522A are combined to form a hypothetical spoken disposable pass phrase. The hypothetical spoken disposable pass phrase includes spoken elements such as spoken element 522A representing the elements of the disposable pass phrase concatenated in sequence. For example, if the disposable pass phrase is “A-B-1-2,” the hypothetical disposable pass phrase includes the following spoken elements of pass phrase elements 512 in the following order: a spoken element representing a spoken “A”; a spoken element representing a spoken “B”; a spoken element representing a spoken “1”; and a spoken element representing a spoken “2”.

Voice authentication module 422 compares the data received in step 606 to the hypothetical spoken disposable pass phrase, compensating for possible variations in the periods between elements. Such compensation in currently available speech/voice recognition systems such as those described above is known and not described further herein. In addition, the time for speaking the disposable pass phrase is limited in this illustrative embodiment, e.g., to three (3) seconds from the time the user is prompted to speak the disposable pass phrase.

If voice authentication module 422 determines that the data received in step 606 does not represent the user associated with identity 502 speaking the disposable pass phrase, i.e., does not match the hypothetical spoken disposable pass phrase, processing transfers to step 109 in which voice authentication module 422 informs computer 305B (FIG. 3) that the user is not authenticated. Conversely, if voice authentication module 422 determines that the data received in step 606 represents the user associated with identity 502 speaking the disposable pass phrase, i.e., matches the hypothetical spoken disposable pass phrase, processing transfers to step 110 in which voice authentication module 422 informs computer 305B (FIG. 3) that the user is not authenticated.

After either step 109 or step 110, processing according to logic flow diagram 100 completes.

Thus, the user is authenticated only if the user knows the name and pass phrase represented by identity 502 and speaks the disposable pass phrase in the previously recorded voice of the user associated with identity 502. In some embodiments, the user must also speak the name and pass phrase represented by identity 502 in the previously recorded voice of the user associated with identity 502.

How computer 305B responds to information from identity authentication unit 307 indicating whether the user is properly authenticated depends upon the particular configuration of computer 305B. Computer 305B can allow a predetermined number of repeat attempts at authentication, and upon successful authentication, allow the user access to the restricted resource.

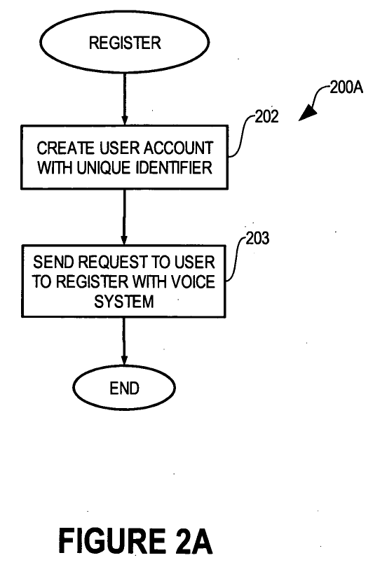

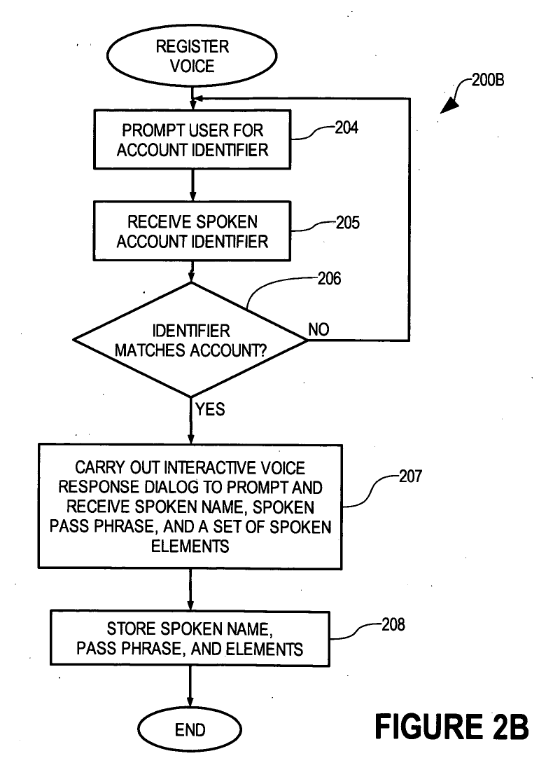

Logic flow diagrams 200A and 200B (FIGS. 2A and 2B, respectively) collectively illustrate the registration of a user by voice registration module 420 (FIG. 4). In step 202 (FIG. 2A), a system administrator creates a unique account for the user, represented by identity 502 (FIG. 5), and an identifier 504 within the system. The system administrator can include other information within identity 502 such as data 506 (including the address, name, and other characteristics of the user).

Other aspects of identity 502 require participation of the user in registration. Accordingly, in step 203 (FIG. 2A), voice registration module 420 (FIG. 4) sends a request to the user to register orally with voice registration module 420. Such a request can be sent to the user by any number of communication channels such as voice, data, or cellular networks. To send this request, identity 502 should already include data specifying a mechanism by which the user can receive such a request. In one embodiment, the system administrator enters data as voice contact 516 and/or name/pass phrase contact 518 to provide information by which voice registration module 420 can contact the user. In another embodiment, the user registers her voice in person while the system administrator observes the registration. For example, the system administrator can be a human resources manager registering a new employee and the new employee can register her voice through a microphone attached to the human resources manager's computer.

Once the user is in communications with voice registration module 420 by some telephonic or oral communications channel, the oral registration with voice registration module 420 is conducted as illustrated by logic flow diagram 200B (FIG. 2B). In step 204, voice registration module 420 prompts the user to speak the user's account identifier, e.g., identifier 504 (FIG. 5). In step 205, voice registration module 420 receives an audio signal representing the user's voice speaking the prompted for identifier. In test step 206, voice registration module 420 uses voice/speech recognition engine 426 to determine whether the received audio signal is recognized as identifier 504. If not, processing returns to step 204 and voice registration module 420 again prompts the user to speak the identifier. After a number of failed matches of the identifier, registration fails.

If, conversely, the received audio signal is recognized as identifier 504, processing transfers from test step 206 to step 207. In step 207, voice registration module 420 uses IVR engine 430 to carry out an IVR dialog with the user to prompt the user to speak her name, pass phrase and a complete set of elements from which disposable pass phrases can be constructed. In step 208, voice registration module 420 stores the spoken name received in step 207 as spoken name 508 (FIG. 5); stores the spoken pass phrase received in step 207 as spoken pass phrase 510; and stores the spoken elements received in step 207 as spoken elements, e.g., spoken element 522A, within pass phrase elements 512. As described above, identity 502 is stored in voiceprint storage 424 for subsequent use in authentication by voice authentication module 422 in the manner described above.

One advantage of the voice-based authentication system described above is that identity authentication unit 307 has the ear of a person, namely, the person being authenticated and has access to information about that person, e.g., as demographic data in data 506. Such provides an opportunity for an opt-in style offer of providing potentially interesting information to the user.

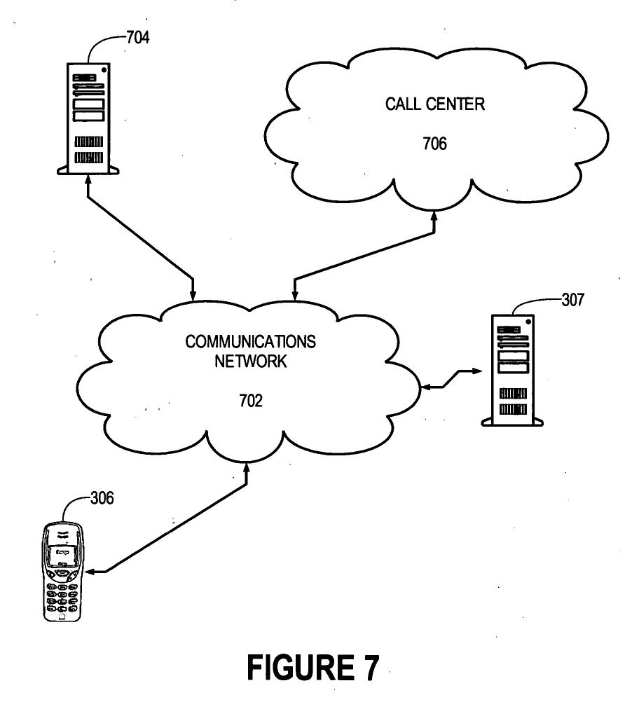

To provide such opt-in offers to the user, identity authentication unit 307 is coupled through communications network 702 (FIG. 7) to an advertisement server 704 and to a call center 706. Communications network 702 includes data network 301 (FIG. 3), wireless network 303, and/or PSTN 302. Advertisement server 704 is a computer system that provides advertising messages in response to requests for such messages. Advertisement server 704 can also provide advertising messages determined to be related to demographic data representing a person. Advertisement server 704 is conventional and known and is not described further herein except in the context of interaction with identity authentication unit 307.

Call center 706 is a network which connects voice calls to one or more customer service representatives. Call center 706 is coupled to communications network 702 in such a manner that call center 706 carry out voice calls between customer service representatives and the user of mobile telephone 306.

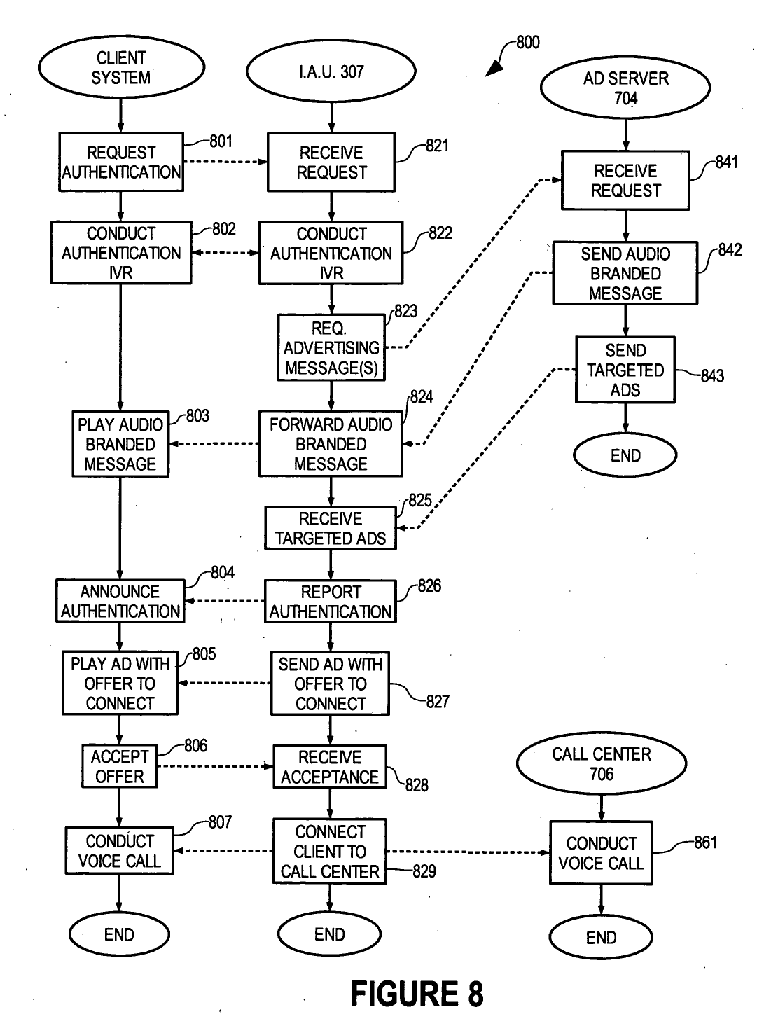

Identity authentication unit 307 cooperates with mobile telephone 306, advertisement server 704, and call center 706 to provide opt-in advertising message service to the user of mobile telephone 306 in a manner illustrated by logic flow diagram 800 (FIG. 8).

In step 801, mobile telephone 306 requests authentication by identity authentication unit 307. Of course, as described above, initiation of the authentication process for the user can be through a channel other than mobile telephone 306. In step 821, identity authentication unit 307 receives the request. In steps 822 and 802, identity authentication unit 307 and mobile telephone 306 conduct an interactive voice response dialog in which the user speaks her user name, pass phrase, and a disposable pass phrase.

In step 823, identity authentication unit 307 requests advertising messages from advertising server 704. Step 823 can be performed concurrently with step 822. However, in a preferred embodiment, identity authentication unit 307 first verifies the identity of the user prior to step 823. In addition, identity authentication unit 307 includes demographic data, e.g., from data 506 (FIG. 5), of the user in the request of step 823. Authentication of the user's identity typically completes very quickly from the user's perspective, i.e., only a small fraction of a second. Accordingly, delaying step 823 until completion of authentication does not delay the user's overall interaction substantially but allows tailoring of advertising messages to the user's demographic data and therefore to the user's interests.

In step 841, advertising server 704 receives the request for advertising messages. In step 842, advertising server 704 sends an audio branded message, e.g., a very brief audio message of a brand. For example, the audio branded message could be “Acme Auto Insurance” stated in a way that conveys reliability and value. In step 843, advertising server 704 sends one or more targeted advertising messages, i.e., messages selected according to the user's demographic information included in the request received in step 841. The targeted advertising messages include data representing an address by which more information regarding the subject matter of the advertising message can be obtained. In this illustrative example, one of the targeted advertising messages includes data representing an address at which call center 706 can be reached should the user be interested in the subject matter of the targeted advertising message. The address can be a telephone number if the voice communication is to be carried out through the PSTN or can be a URL if the voice communication is to be carried out through VoIP.

By separating steps 842 and 843, advertising server 704 can respond almost immediately with a short audio branded message while continuing to gather one or more targeted advertising messages for sending in step 843. In an alternative embodiment, steps 842 and 843 are combined into a single step.

In step 824, identity authentication unit 307 forwards the audio branded message from advertising server 704 to mobile telephone 306 as an audio signal for playback to the user in step 803.

In step 825, identity authentication unit 307 receives the one or more targeted advertising messages sent by advertising server 704 in step 843.

In step 826, identity authentication unit 307 reports successful authentication of the user. Mobile telephone 306 receives the report as an audio signal and plays the report to the user in step 804. Thus, successful authentication is reported prior to playing any advertising messages, allowing the user to terminate the phone call and continue with access of the restricted resource.

In step 827, identity authentication unit 307 sends a targeted ad received from advertising server 704 as an audio signal for playing to the user through mobile telephone 306 in step 805. The targeted advertising message includes an offer to connect the user to a customer service representative for assistance in connection with the subject matter of the targeted advertising message. For example, the targeted advertising message could be “Acme auto insurance guarantees the lowest rates. For a free quote, please press or say ‘one.’”

In step 806, the user presses or says “one” using mobile telephone 306. Such a response is received and recognized by identity authentication unit 307 in step 828. In step 829, identity authentication server 307 connects mobile telephone 306 with call center 706 for voice communication therebetween.

Identity authentication unit 307 can connect mobile telephone 306 with call center 706 in a number of ways. In one embodiment, identity authentication unit 307 is implemented in co-located telephone equipment and therefore has direct access to PSTN switches and can therefore transfer the voice call with mobile telephone 306 from itself to call center 706. In an alternative embodiment, the user interacts with identity authentication unit 307 through a VoIP connection. In this alternative embodiment, identity authentication unit 307 can redirect the VoIP connection with mobile telephone 306 from identity authentication unit 307 to call center 706. Alternatively, identity authentication unit 307 can open a new VoIP connection between mobile telephone 306 and call center 706 while maintaining the existing connection between identity authentication unit 307 and mobile telephone 306. Maintain the existing connection allows identity authentication unit 307 to measure the duration for which mobile telephone 306 remains connected to both identity authentication unit 307 and call center 706. Accordingly, identity authentication unit 307 can confirm that mobile telephone 306 is successfully connected with call center 706 when mobile telephone 306 remains connected for more than a trivial amount of time, e.g., 30 seconds.

In implementations in which cost to the consumer must be kept to a minimum but security can not be compromised, interjecting targeted advertising messages in this manner enables allocation of the requisite resources for the heightened security offered by the authentication mechanism described above by subsidizing such resources with advertising revenue.

The above description is illustrative only and is not limiting. Instead, the present invention is defined solely by the claims which follow and their full range of equivalents.

What is claimed is:

1. A method for authenticating a requesting user as a recognized user, the method comprising:
receiving a request to authenticate the requesting user as the recognized user;
generating a disposable pass phrase in response to the request;
sending the disposable pass phrase to the requesting user;
receiving an audio signal in response to the disposable pass phrase;
determining whether the audio signal represents a voice of the recognized user by comparing the audio signal to a control audio signal that represents the disposable pass phrase spoken by the recognized user; and
authenticating the requesting user as the recognized user upon a condition in which determining determines that the audio signal represents a voice of the recognized user.

2. The method of claim 1 wherein the disposable pass phrase is a password.

3. The method of claim 1 wherein generating the disposable pass phrase includes:
selecting one or more elements from a collection of two or more elements in a randomized manner; and
combining the selected elements to form the disposable pass phrase so as to include the selected elements.

4. The method of claim 3 wherein the control audio signal is a combination of prerecorded spoken elements of the recognized user, wherein the prerecorded spoken elements correspond to the selected elements of the disposable pass phrase.

5. The method of claim 3 wherein one or more of the elements of the collection correspond to respective letters of an alphabet.

6. The method of claim 3 wherein one or more of the elements of the collection correspond to respective numerals.

7. The method of claim 3 wherein determining comprises:
determining whether the audio signal represents the voice of the recognized user speaking the disposable pass phrase.

8. The method of claim 1 further comprising:
receiving an account identifying audio signal;
determining whether the account identifying audio signal represents the voice of the recognized user speaking a predetermined account identifier of the recognized user; and
authenticating the requesting as the recognized user upon both (i) the condition in which the audio signal represents the voice of the recognized user determines and (ii) a condition in which the account identifying audio signal represents the voice of the user speaking the predetermined account identifier.

9. The method of claim 8 further comprising:
receiving an account pass phrase audio signal;
determining whether the account pass phrase audio signal represents the voice of the recognized user speaking a predetermined account pass phrase of the recognized user; and
authenticating the requesting as the recognized user upon (i) the condition in which the audio signal represents the voice of the recognized user determines, (ii) the condition in which the account identifying audio signal represents the voice of the user speaking the predetermined account identifier, and (iii) a condition in which the account pass phrase audio signal represents the voice of the user speaking the predetermined account pass phrase.

10. The method of claim 1 wherein receiving the audio signal comprises:
initiating voice communications with the requesting user to establish a voice channel with the requesting user;
receiving the audio signal through the voice channel.

11. The method of claim 10 wherein initiating comprises initiating voice communications with the requesting user at a predetermined voice communications address associated with the recognized user.

12. The method of claim 11 wherein the voice communications address is a telephone number.

13. The method of claim 11 wherein the voice communications address is a user identifier of a voice-communication-enabled instant messaging system.

14. The method of claim 1 further comprising:
sending a sponsored audio message to the requesting user.

15. The method of claim 14 wherein the sponsored audio message is an audio branded message.

16. The method of claim 14 wherein sending the sponsored audio message is performed after authenticating the requesting user as the recognized user.

17. The method of claim 14 further comprising:
connecting the requesting user with a sponsor of the sponsored audio message.

18. The method of claim 14 wherein connecting the requesting user with a sponsor of the sponsored audio message is performed in response to a user-generated signal representing consent of the requesting user to the connecting.

19. The method of claim 14 wherein connecting comprises:
opening a voice communications channel between the requesting user and the sponsor.

20. A computer readable medium useful in association with a computer which includes a processor and a memory, the computer readable medium including computer instructions which are configured to cause the computer to authenticate a requesting user as a recognized user by:
receiving a request to authenticate the requesting user as the recognized user;
generating a disposable pass phrase in response to the request;
sending the disposable pass phrase to the requesting user;
receiving an audio signal in response to the disposable pass phrase;
determining whether the audio signal represents a voice of the recognized user by comparing the audio signal to a control audio signal that represents the disposable pass phrase spoken by the recognized user; and
authenticating the requesting user as the recognized user upon a condition in which determining determines that the audio signal represents a voice of the recognized user.

21. The computer readable medium of claim 20 wherein the disposable pass phrase is a password.

22. The computer readable medium of claim 20 wherein generating the disposable pass phrase includes:
selecting one or more elements from a collection of two or more elements in a randomized manner; and
combining the selected elements to form the disposable pass phrase so as to include the selected elements.

23. The computer readable medium of claim 22 wherein the control audio signal is a combination of prerecorded spoken elements of the recognized user, wherein the prerecorded spoken elements correspond to the selected elements of the disposable pass phrase.

24. The computer readable medium of claim 22 wherein one or more of the elements of the collection correspond to respective letters of an alphabet.

25. The computer readable medium of claim 22 wherein one or more of the elements of the collection correspond to respective numerals.

26. The computer readable medium of claim 22 wherein determining comprises:
determining whether the audio signal represents the voice of the recognized user speaking the disposable pass phrase.

27. The computer readable medium of claim 20 wherein the computer instructions are configured to cause the computer to authenticate a requesting user as a recognized user by also:
receiving an account identifying audio signal;
determining whether the account identifying audio signal represents the voice of the recognized user speaking a predetermined account identifier of the recognized user; and
authenticating the requesting as the recognized user upon both (i) the condition in which the audio signal represents the voice of the recognized user determines and (ii) a condition in which the account identifying audio signal represents the voice of the user speaking the predetermined account identifier.

28. The computer readable medium of claim 27 wherein the computer instructions are configured to cause the computer to authenticate a requesting user as a recognized user by also:
receiving an account pass phrase audio signal;
determining whether the account pass phrase audio signal represents the voice of the recognized user speaking a predetermined account pass phrase of the recognized user; and
authenticating the requesting as the recognized user upon (i) the condition in which the audio signal represents the voice of the recognized user determines, (ii) the condition in which the account identifying audio signal represents the voice of the user speaking the predetermined account identifier, and (iii) a condition in which the account pass phrase audio signal represents the voice of the user speaking the predetermined account pass phrase.

29. The computer readable medium of claim 20 wherein receiving the audio signal comprises:
initiating voice communications with the requesting user to establish a voice channel with the requesting user;
receiving the audio signal through the voice channel.

30. The computer readable medium of claim 29 wherein initiating comprises initiating voice communications with the requesting user at a predetermined voice communications address associated with the recognized user.

31. The computer readable medium of claim 30 wherein the voice communications address is a telephone number.

32. The computer readable medium of claim 30 wherein the voice communications address is a user identifier of a voice-communication-enabled instant messaging system.

33. The computer readable medium of claim 20 wherein the computer instructions are configured to cause the computer to authenticate a requesting user as a recognized user by also:
sending a sponsored audio message to the requesting user.

34. The computer readable medium of claim 33 wherein the sponsored audio message is an audio branded message.

35. The computer readable medium of claim 33 wherein sending the sponsored audio message is performed after authenticating the requesting user as the recognized user.

36. The computer readable medium of claim 33 wherein the computer instructions are configured to cause the computer to authenticate a requesting user as a recognized user by also:
connecting the requesting user with a sponsor of the sponsored audio message.

37. The computer readable medium of claim 33 wherein connecting the requesting user with a sponsor of the sponsored audio message is performed in response to a user-generated signal representing consent of the requesting user to the connecting.

38. The computer readable medium of claim 33 wherein connecting comprises:
opening a voice communications channel between the requesting user and the sponsor.

39. A computer system comprising:
a processor;
a memory operatively coupled to the processor; and
an authentication module (i) which executes in the processor from the memory and (ii) which, when executed by the processor, causes the computer to authenticate a requesting user as a recognized user by:
receiving a request to authenticate the requesting user as the recognized user;
generating a disposable pass phrase in response to the request;
sending the disposable pass phrase to the requesting user;
receiving an audio signal in response to the disposable pass phrase;
determining whether the audio signal represents a voice of the recognized user by comparing the audio signal to a control audio signal that represents the disposable pass phrase spoken by the recognized user; and
authenticating the requesting user as the recognized user upon a condition in which determining determines that the audio signal represents a voice of the recognized user.

40. The computer system of claim 39 wherein the disposable pass phrase is a password.

41. The computer system of claim 39 wherein generating the disposable pass phrase includes:
selecting one or more elements from a collection of two or more elements in a randomized manner; and
combining the selected elements to form the disposable pass phrase so as to include the selected elements.

42. The computer system of claim 41 wherein the control audio signal is a combination of prerecorded spoken elements of the recognized user, wherein the prerecorded spoken elements correspond to the selected elements of the disposable pass phrase.

43. The computer system of claim 41 wherein one or more of the elements of the collection correspond to respective letters of an alphabet.

44. The computer system of claim 41 wherein one or more of the elements of the collection correspond to respective numerals.

45. The computer system of claim 41 wherein determining comprises:
determining whether the audio signal represents the voice of the recognized user speaking the disposable pass phrase.

46. The computer system of claim 39 wherein the authentication module is configured to cause the computer to authenticate a requesting user as a recognized user by also:
receiving an account identifying audio signal;
determining whether the account identifying audio signal represents the voice of the recognized user speaking a predetermined account identifier of the recognized user; and
authenticating the requesting as the recognized user upon both (i) the condition in which the audio signal represents the voice of the recognized user determines and (ii) a condition in which the account identifying audio signal represents the voice of the user speaking the predetermined account identifier.

47. The computer system of claim 46 wherein the authentication module is configured to cause the computer to authenticate a requesting user as a recognized user by also:
receiving an account pass phrase audio signal;
determining whether the account pass phrase audio signal represents the voice of the recognized user speaking a predetermined account pass phrase of the recognized user; and
authenticating the requesting as the recognized user upon (i) the condition in which the audio signal represents the voice of the recognized user determines, (ii) the condition in which the account identifying audio signal represents the voice of the user speaking the predetermined account identifier, and (iii) a condition in which the account pass phrase audio signal represents the voice of the user speaking the predetermined account pass phrase.

48. The computer system of claim 39 wherein receiving the audio signal comprises:
initiating voice communications with the requesting user to establish a voice channel with the requesting user;
receiving the audio signal through the voice channel.

49. The computer system of claim 48 wherein initiating comprises initiating voice communications with the requesting user at a predetermined voice communications address associated with the recognized user.

50. The computer system of claim 49 wherein the voice communications address is a telephone number.

51. The computer system of claim 49 wherein the voice communications address is a user identifier of a voice-communication-enabled instant messaging system.

52. The computer system of claim 39 wherein the authentication module is configured to cause the computer to authenticate a requesting user as a recognized user by also:
sending a sponsored audio message to the requesting user.

53. The computer system of claim 52 wherein the sponsored audio message is an audio branded message.

54. The computer system of claim 52 wherein sending the sponsored audio message is performed after authenticating the requesting user as the recognized user.

55. The computer system of claim 52 wherein the authentication module is configured to cause the computer to authenticate a requesting user as a recognized user by also:
connecting the requesting user with a sponsor of the sponsored audio message.

56. The computer system of claim 52 wherein connecting the requesting user with a sponsor of the sponsored audio message is performed in response to a user-generated signal representing consent of the requesting user to the connecting.

57. The computer system of claim 52 wherein connecting comprises:
opening a voice communications channel between the requesting user and the sponsor.
